(19) United States
(12) Patent Application Publication
(10) Pub. No.: US 2024/0332849 A1
(43) Pub. Date: Oct. 3, 2024

(54) Electrical Connector Housing and Electrical Connector

(71) Applicants: Tyco Electronics (Suzhou) Ltd., Suzhou City (CN); Tyco Electronics (Shanghai) Co., Ltd., Shanghai (CN)

(72) Inventors: Kang Zhou, Suzhou (CN); Jun Zong, Shanghai (CN); Tao (Thomson) Dong, Suzhou (CN)

(73) Assignees: Tyco Electronics (Suzhou) Ltd., Suzhou City (CN); Tyco Electronics (Shanghai) Co., Ltd., Shanghai (CN)

(21) Appl. No.: 18/618,347

(22) Filed: Mar. 27, 2024

(30) Foreign Application Priority Data
Mar. 27, 2023 (CN) 202320628364.9

(51) Int. Cl. H01R 13/506; H01R 12/69

(52) U.S. Cl. CPC H01R 13/506; H01R 12/69

(57) ABSTRACT

An electrical connector housing includes a terminal receiving housing part and a cover part independent of the terminal receiving housing part. The terminal receiving housing part defines a receiving slot receiving a plurality of connection terminals and a circuit board. The terminal receiving housing part and the cover part are capable of being assembled together.

### CROSS-REFERENCE TO RELATED APPLICATION

This application claims the benefit of the filing date under 35 U.S.C. § 119 (a)-(d) of Chinese Patent Application No. 202320628364.9, filed on Mar. 27, 2023.

### FIELD OF INVENTION

The present disclosure generally relates to electrical connectors, and in particular, to an electrical connector housing and an electrical connector.

### BACKGROUND

In the application scenarios of existing electrical connectors for flexible printed circuit boards, connection terminals are pre-installed on the flexible printed circuit board to achieve physical and electrical connections between electrical contacts on the flexible printed circuit board and the connection terminals, and to form an assembly of the flexible printed circuit board and the connection terminals. Then, the assembly of the flexible printed circuit board and the connection terminals is inserted into a pocket of a housing of the electrical connector as a whole to form a complete electrical connector for the flexible printed circuit board.

In practice, because the physical and electrical connections between the electrical contacts on the flexible printed circuit board and the connection terminals are achieved by crimping, due to the large number of the connection terminals and the influence of the crimped position, during the process of inserting the assembly of the flexible printed circuit board and the connection terminals into the pocket of the electrical connector housing, the accumulated friction force between elastic sheets of the connection terminals themselves and the pocket of the housing made of plastic is large. A certain strength of insertion force is usually required to fully insert the assembly into the pocket of the electrical connector housing. Moreover, the flexible characteristics of the circuit board also make it difficult for the assembly to be inserted into the pocket of the electrical connector housing, further increasing the difficulty of insertion. In addition, the insertion method of the assembly can easily cause damage to copper foils of crimping portions of the connection terminals, which are not visible after insertion and there is serious quality risk.

Moreover, in the related art, the electrical connector housing has poor tolerance for an adhesive dispensed in the puncturing and crimping region of the flexible circuit board, and has strict specification requirements for the thickness of adhesive dispensing. Once this dispensing thickness exceeds the specification requirements, the flexible circuit board will be difficult to insert. In addition, in the related art, there is still a problem of inaccurate alignment between the connection terminals and through holes of the housing when the assembly of the flexible printed circuit board and the connection terminals is inserted into the pocket of the electrical connector housing.

### SUMMARY

An electrical connector housing includes a terminal receiving housing part and a cover part independent of the terminal receiving housing part. The terminal receiving housing part defines a receiving slot receiving a plurality of connection terminals and a circuit board. The terminal receiving housing part and the cover part are capable of being assembled together.

### BRIEF DESCRIPTION OF THE DRAWINGS

Features of the present invention will become more apparent by describing in detail exemplary embodiments thereof with reference to the accompanying drawings, in which:

FIG. 1 is a schematic structural view showing an electrical connector housing according to the exemplary embodiment of the present disclosure, wherein a cover part and a terminal receiving housing part are assembled together;

FIG. 2 is another schematic structural view showing the electrical connector housing according to the exemplary embodiment of the present disclosure, wherein the cover part and the terminal receiving housing part are separated from each other;

FIG. 3 is a schematic structural view showing the electrical connector according to the exemplary embodiment of the present disclosure, wherein connection terminals and a circuit board have been locked in the receiving slot of the electrical connector housing;

FIG. 4 is a schematic structural view showing the electrical connector according to the exemplary embodiment of the present disclosure, wherein the cover part is omitted to show that connecting terminals and the circuit board have been locked in the receiving slot of the electrical connector housing; and

FIG. 5 is a schematic sectional view of the electrical connector shown in FIG. 3.

### DETAILED DESCRIPTION OF EMBODIMENTS

Embodiments of the present disclosure will be described hereinafter in detail taken in conjunction with the accompanying drawings. In the description, the same or similar parts are indicated by the same or similar reference numerals. The description of each of the embodiments of the present disclosure hereinafter with reference to the accompanying drawings is intended to explain the general inventive concept of the present disclosure and should not be construed as a limitation on the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

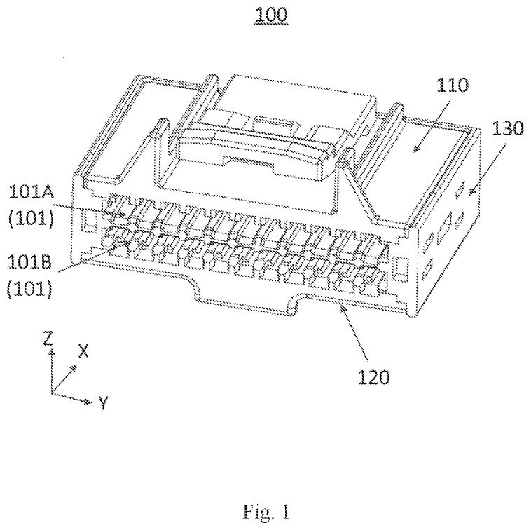

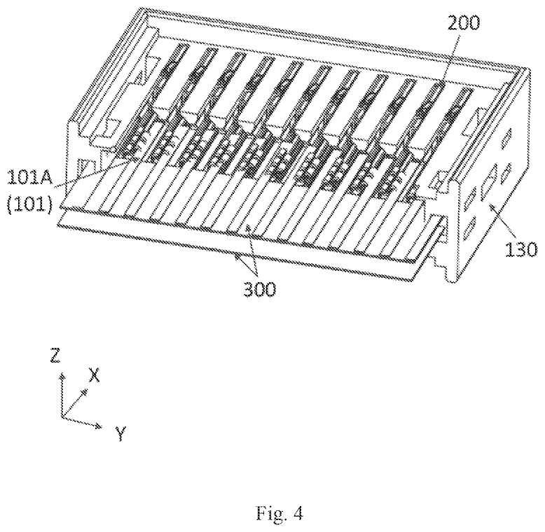

In the description of exemplary embodiments shown in FIGS. 1 to 5 herein, for case of explanation and illustration, a longitudinal extension direction of a single connection terminal 200 placed into an electrical connector housing 100 is defined as a first direction X, a direction along which a plurality of connection terminals 200 are arranged side by side is defined as a second direction Y, and a direction perpendicular to both the first direction X and the second direction Y is defined as a third direction Z.

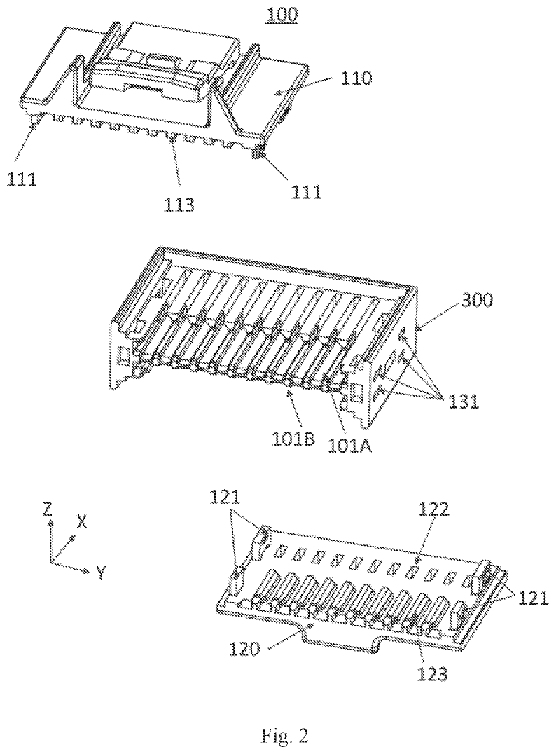

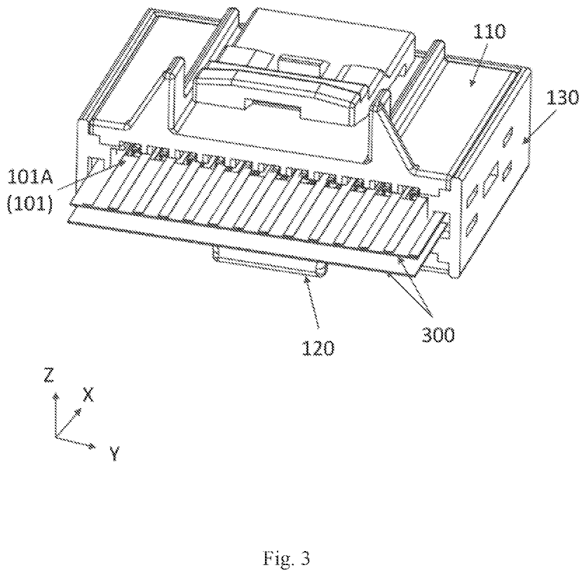

Referring to FIGS. 1 and 2, according to an embodiment of the present disclosure, there is provided an electrical connector housing 100 including: a terminal receiving housing part 130 and a cover part 110, 120 independent of the terminal receiving housing part 130. The terminal receiving housing part 130 defines a receiving slot 101 for receiving a plurality of connection terminals 200 (see FIGS. 3 to 5) and a circuit board 300 (see FIGS. 3 to 5). According to the embodiments of the present disclosure, the terminal receiving housing part (130) and the cover part (110, 120) are configured to be capable of being assembled together.

Further, as shown in FIG. 2, the cover part 110, 120 is provided with a first engagement portion 111, 121, and the terminal receiving housing part 130 is provided with a second engagement portion 131. The first engagement portion 111, 121 and the second engagement portion 131 are configured to be capable of being engaged with each other when the cover part 110, 120 and the terminal receiving housing part 130 are assembled together, so that the receiving slot 101 is kept closed (as shown in FIG. 1). The “close” described herein may refer to the restoration of the electrical connector housing 100, along with the receiving slot 101 therein, to the same conventional state as the integrated housing and pocket thereof in the related art.

According to the embodiments of the present disclosure, the electrical connector housing 100 adopts a split design in which the terminal receiving housing part 130 and the cover part 110, 120 are independent of each other to expose the receiving slot 101, for example, as shown in FIG. 2, when the terminal receiving housing part 130 and the cover part 110, 120 are not assembled together. An assembly of the connection terminals 200 and the circuit board 300 (the “assembly” described herein may refer to an integral part formed after the connection terminals 200 and the circuit board 300 are previously connected together by soldering, etc.) can be easily placed into the receiving slot 101, that is, it is convenient to place the connection terminals 200 or the circuit board 300, or the connection terminals 200 and the flexible circuit board 300 can be assembled into the receiving slot 101 of the electrical connector housing 100 with application of only a small external force or even no external force, fundamentally overcoming various defects caused by the insertion method of the assembly adopted in the related art.

In the exemplary embodiment shown in FIGS. 1 and 2, the first engagement portion 111, 121 and the second engagement portion 131 are engaged in a snap-fit manner, wherein one (in the exemplary embodiment shown, the first engagement portion 111, 121) of the first engagement portion 111, 121 and the second engagement portion 131 is an elastic sheet with a protruding block, and the other (in the illustrated exemplary embodiment, the second engagement portion 131) of the first engagement portion 111, 121 and the second engagement portion 131 is an opening being capable of accommodating the protruding block. In other embodiments of the present disclosure, the first engagement portion 111, 121 and the second engagement portion 131 are engaged in any other suitable manner of fastening fit (for example, one of the first engagement portion 111, 121 and the second engagement portion 131 is an insert, and the other of the first engagement portion 111, 121 and the second engagement portion 131 has a hole being capable of accommodating the insert), as long as the receiving slot 101 can be kept closed when the terminal receiving housing part 130 and the cover part 110, 120 are assembled together.

According to the exemplary embodiments of the present disclosure, as shown in FIG. 2, the cover part 110, 120 is provided with the first engagement portion 111, 121 on both sides of the receiving slot 101, respectively; the terminal receiving housing part 130 is correspondingly provided with the second engagement portions 131 on both sides of the receiving slot 101, respectively. In an embodiment, the cover part 110, 120 is correspondingly provided with one or more first engagement portion 111, 121 on both sides of the receiving slot 101, respectively, and the terminal receiving housing part 130 is correspondingly provided with one or more second engagement portion 131 on both sides of the receiving slot 101, respectively. For example, as shown in FIG. 2, the cover part 120 is correspondingly provided with two first engagement portion 121 on each of both sides of the receiving slot 101 (i.e. along the second direction Y), respectively, and the terminal receiving housing part 130 is correspondingly provided with two second engagement portion 131 on each of both sides of the receiving slot 101 (i.e. along the second direction Y), respectively. With this configuration, it is beneficial to firmly keep the receiving slot 101 closed when the terminal receiving housing part 130 and the cover part 110, 120 are assembled together.

According to the exemplary embodiments of the present disclosure, as shown in FIGS. 1 and 2, the first engagement portion 111, 121 is integrally formed with the cover part 110, 120 and the second engagement portion 131 is integrally formed with the terminal receiving housing part 130. For example, in an embodiment, the first engagement portion 111 and the cover part 110 can be integrally formed from plastic material, the first engagement portion 121 and the cover part 120 can be integrally formed from plastic material, and the second engagement portion 131 and the terminal receiving housing part 130 can also be integrally formed from plastic material.

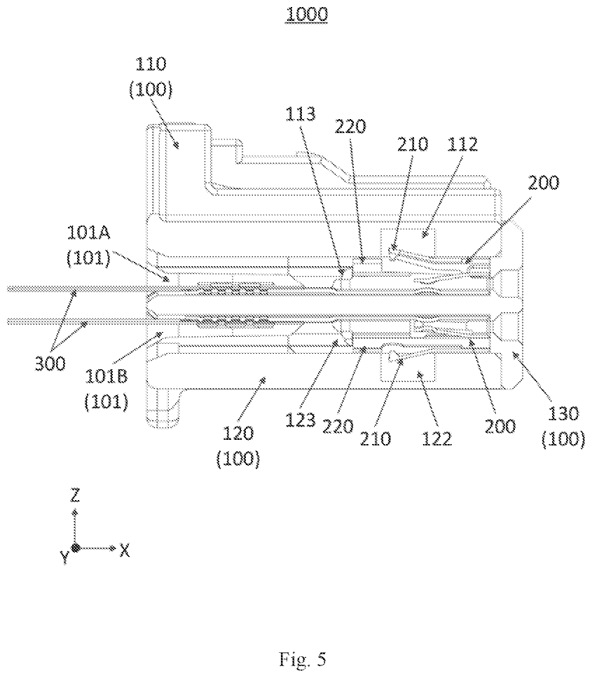

According to the present disclosure, the cover part 110, 120 is formed with a locking block 113, 123 extending into the receiving slot 101, the locking block 113, 123 being configured to abut against the connection terminal 200 placed into the receiving slot 101. According to the exemplary embodiments of the present disclosure, as shown in FIG. 5, the cover part 110, 120 may be formed with a locking block 113, 123 extending into the receiving slot 101, the locking block 113, 123 being configured to abut against the connection terminal 200 placed into the receiving slot 101. More specifically, for example, as shown in FIG. 5, the locking block 113, 123 is configured to abut against a crimping portion 220 of the connection terminal 200 placed into the receiving slot 101. As shown in FIG. 5, when the receiving slot 101 is kept closed, an end face of the crimping portion 220 of the connection terminal 200 abuts against the locking block 113, 123, thereby effectively locking the assembly of the connection terminals 200 and the circuit board 300 in an appropriate position within the receiving slot 101 (101A, 101B).

According to the present disclosure, the cover part 110, 120 is formed with a locking notch 112, 122, the locking notch 112, 122 being configured to allow the connection terminal 200 to extend thereinto and to abut against the connection terminal 200. According to the exemplary embodiments of the present disclosure, as shown in FIG. 5, the cover part 110, 120 may further be formed with the locking notch 112, 122, the locking notch 112, 122 being configured to allow the connection terminal 200 to extend thereinto and to abut against the connection terminal 200. In the embodiment shown in FIG. 5, the locking notch 112, 122 is configured to allow an elastic sheet portion 210 of the connection terminal 200 to extend thereinto and to abut against the connection terminal 200. For example, as shown in FIG. 5, when the receiving slot 101 is kept closed, at least a section of the elastic sheet portion 210 of the connection terminal 200 extends into the locking notch 112, 122, and an end of the elastic sheet portion 210 abuts against a wall of the locking notch 112, 122, thereby further locking the assembly of the connection terminals 200 and the circuit board 300 in the appropriate position within the receiving slot 101. It should be noted that, regarding the abovementioned locking notch 112, 122, in the embodiment shown in the figure, the locking notch may be a blind-hole formed in an inner surface of the cover part 110, 120, that is, it does not penetrate through the cover part 110, 120. In another embodiment, the locking notch 112 and 122 may penetrate through the cover part 110, 120.

According to the present disclosure, as shown in FIGS. 1 and 2, the cover part 110, 120 includes a first cover part 110 and a second cover part 120. The terminal receiving housing part 130 further defines a first receiving slot 101A and a second receiving slot 101B for receiving the plurality of connection terminals 200 and the circuit board 300. The first receiving slot 101A and the second receiving slot 101B are positioned on opposite sides of the terminal receiving housing portion 130, respectively. For example, as shown in FIGS. 1 and 2, the first receiving slot 101A and the second receiving slot 101B are positioned on opposite sides of the terminal receiving housing part 130 along the third direction Z, respectively. With this configuration, the electrical connector housing provided by the embodiments of the present disclosure can receive two assemblies of the connection terminals 200 and the circuit board 300.

With the electrical connector housing provided by the embodiments of the present disclosure, when the terminal receiving housing part and the cover part are assembled together, the electrical connector housing can effectively and accurately lock the assembly of the connection terminals and the circuit board in the receiving slot of the electrical connector housing and, at the same time, ensure accurate alignment between the connecting terminals and the through holes of the housing. Moreover, the assembly of the connection terminals and the flexible circuit board is placed and locked in the electrical connector housing, avoiding damage to the adhesive dispensing of the crimping portion of the connection terminal and, therefore, the tolerance for the adhesive dispensing of the crimping portion of the connection terminals is improved, the thickness requirement is no longer strict, and the overall pressure resistance of the electrical connector is significantly improved.

According to the embodiments of the present disclosure, there is also provides an electrical connector. Referring to FIG. 5, the electrical connector 1000 including: the electrical connector housing 100 according to any one of the aforementioned embodiments; a plurality of connection terminals 200; and a circuit board 300. The plurality of connection terminals 200 and the circuit board 300 are connected together and placed into the receiving slot 101 of the electrical connector housing 100.

According to the exemplary embodiments of the present disclosure, as shown in FIG. 2, before the installation or assembling process of the electrical connector, the terminal receiving housing part 130 and the cover part 110, 120 are not assembled together, and the receiving slot 101 of the electrical connector housing 100 is exposed, the assembly of the connection terminals 200 and the circuit board 300 can be easily placed into the receiving slot 101. During the installation or assembling process of the electrical connector, in the exemplary embodiments illustrated, as shown in FIGS. 3 to 5, the plurality of connection terminals 200 are arranged side by side in the electrical connector housing 100 along the second direction Y, and more specifically, arranged side by side in the second housing part 120.

According to the exemplary embodiments of the present disclosure, as shown in FIG. 5, cach connection terminal 200 may include a crimping portion 220, and the cover part 110, 120 of the electrical connector housing 100 is formed with a locking block 113, 123 extending into the receiving slot 101. For example, as shown in FIG. 5, after the installation or assembling of the electrical connector is completed, the receiving slot 101 is kept closed, and an end face of the crimping portion 220 of the connection terminal 200 abuts against the locking block 113, 123, thereby effectively locking the assembly of the connection terminals 200 and the circuit board 300 in an appropriate position within the receiving slot 101.

According to the exemplary embodiments of the present disclosure, as shown in FIG. 5, each connection terminal 200 may further include an elastic sheet portion 210, and the cover part 110, 120 is formed with a locking notch 112, 122. For example, as shown in FIG. 5, after the installation or assembling of the electrical connector is completed, the receiving slot 101 is kept closed, and at least a section of the elastic sheet portion 210 of the connection terminal 200 extends into the locking notch 112, 122, and an end of the elastic sheet portion 210 abuts against the locking notch 112, 122, thereby further locking the assembly of the connection terminals 200 and the circuit board 300 in the appropriate position within the receiving slot 101.

Therefore, with the electrical connector 1000 provided by the embodiments of the present disclosure, after the installation or assembling of the electrical connector 1000 is completed, the receiving slot 101 of the electrical connector housing 100 is kept closed, and the assembly of the connection terminals 200 and the circuit board 300 can be effectively locked in the receiving slot 101 of the electrical connector housing 100.

According to the exemplary embodiments of the present disclosure, as shown in FIGS. 3 to 5, the plurality of connection terminals 200 are configured to be engaged with the circuit board 300 in a crimping manner. The circuit board 300 described herein may be a flexible printed circuit board.

In this way, with the electrical connector 1000 provided by the embodiments of the present disclosure, the assembly of the connection terminals 200 and the flexible printed circuit board 300 is placed and locked in the electrical connector housing 100, avoiding damage to the adhesive dispensing of the crimping portion 220 of the connecting terminal 200, thus, the tolerance for the adhesive dispensing of the crimping portion 220 of the connection terminal 200 is improved, the thickness requirement is no longer strict, and the overall pressure resistance of the electrical connector 1000 is significantly improved.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate embodiments of the present disclosure by way of example, and should not be construed as limiting the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in claims and their equivalents.

It should be noted that, the word “comprise” or “include” doesn't exclude other elements or steps, and the word “a” or “an” doesn't exclude more than a plurality. In addition, any reference numerals in the claims should not be interpreted as the limitation to the scope of the present disclosure.

What is claimed is:

1. An electrical connector housing, comprising:
a terminal receiving housing part defining a receiving slot receiving a plurality of connection terminals and a circuit board; and
a cover part independent of the terminal receiving housing part, the terminal receiving housing part and the cover part are capable of being assembled together.

2. The electrical connector housing of claim 1, wherein the cover part has a first engagement portion and the terminal receiving housing part has a second engagement portion, the first engagement portion and the second engagement portion engage with each other when the cover part and the terminal receiving housing are assembled together.

3. The electrical connector housing of claim 2, wherein the first engagement portion and the second engagement portion engage in a snap-fit manner.

4. The electrical connector housing of claim 3, wherein one of the first engagement portion and the second engagement portion is an elastic sheet with a protruding block and the other of the first engagement portion and the second engagement portion is an opening capable of accommodating the protruding block.

5. The electrical connector housing of claim 2, wherein one of the first engagement portion and the second engagement portion is an insert and the other of the first engagement portion and the second engagement portion has a hole capable of accommodating the insert.

6. The electrical connector housing of claim 2, wherein the cover part has the first engagement portion on each of a pair of sides of the receiving slot.

7. The electrical connector housing of claim 6, wherein the terminal receiving housing part has the second engagement portion on each of the pair of sides of the receiving slot.

8. The electrical connector housing of claim 7, wherein the first engagement portion is one of a plurality of first engagement portions on each of the pair of sides of the receiving slot.

9. The electrical connector housing of claim 8, wherein the second engagement portion is one of a plurality of second engagement portions of each of the pair of sides of the receiving slot.

10. The electrical connector housing of claim 2, wherein the first engagement portion is integrally formed with the cover part and the second engagement portion is integrally formed with the terminal receiving housing part.

11. The electrical connector housing of claim 1, wherein the cover part has a locking block extending into the receiving slot.

12. The electrical connector housing of claim 11, wherein the locking block abuts against one of the connection terminals placed in the receiving slot.

13. The electrical connector housing of claim 12, wherein the cover part has a locking notch, the one of the connection terminals extends into the locking notch.

14. The electrical connector housing of claim 1, wherein the cover part has a first cover part and a second cover part.

15. The electrical connector housing of claim 1, wherein the receiving slot is one of a first receiving slot and a second receiving slot of the terminal receiving housing part receiving the connection terminals and the circuit board, the first receiving slot and the second receiving slot are positioned on opposite sides of the terminal receiving housing part.

16. An electrical connector, comprising:
an electrical connector housing including a terminal receiving housing part and a cover part independent of the terminal receiving housing part, the terminal receiving housing part defines a receiving slot, the terminal receiving housing part and the cover part are capable of being assembled together;
a plurality of connection terminals; and
a circuit board, the connection terminals and the circuit board are connected together and placed into the receiving slot of the electrical connector housing.

17. The electrical connector of claim 16, wherein the cover part has a locking block extending into the receiving slot, each of the connection terminals has a crimping portion abutting against the locking block.

18. The electrical connector of claim 16, wherein the cover part has a locking notch, each of the connection terminals has an elastic sheet portion extending into the locking notch, an end of the elastic sheet portion abuts against the locking notch.

19. The electrical connector of claim 16, wherein the connection terminals are engaged with the circuit board in a crimping manner.

20. The electrical connector of claim 19, wherein the circuit board is a flexible printed circuit board.
